(19) United States
(12) Patent Application Publication
(10) Pub. No.: US 2004/0260405 A1
(43) Pub. Date: Dec. 23, 2004

(54) Modular monitoring, control and device management for use with process control systems

(76) Inventors: Ron Eddie, Austin, TX (US); Mark J. Nixon, Round Rock, TX (US); Michael L. Sheldon, Georgetown, TX (US)

Correspondence Address: GROSSMAN & FLIGHT, LLC, 20 N. WACKER DRIVE, SUITE 4220, CHICAGO, IL, 60606, US

(21) Appl. No.: 10/464,722

(22) Filed: Jun. 18, 2003

(51) Int. Cl. G05B 19/18; G05B 11/01; G05B 9/02; G05B 19/42

(52) U.S. Cl. 700/3; 700/19; 700/82

(57) ABSTRACT

Disclosed herein are methods, apparatus and articles of manufacture that provide modular monitoring, control and device management in a process control system. According to one example a method of replacing a first field device of a process control system with a second field device, wherein the first field device includes a removable data storage device includes extracting the removable storage device from the first field device, removing the first field device from the process control system, installing the second field device into the process control system; and installing the removable data storage device into the second field device.

### TECHNICAL FIELD

The present disclosure generally relates to process control systems and, more particularly, to modular monitoring, control and device management for use with process control systems.

### BACKGROUND

Process control systems are widely used in factories and/or plants in which products are manufactured or processes are controlled (e.g., chemical manufacturing, power plant control, etc.) Process control systems are also used in the harvesting of natural resources such as, for example, oil and gas drilling and handling processes, etc. Virtually any manufacturing process, resource harvesting process, etc. can be automated through the application of one or more process control systems.

The manner in which process control systems are implemented has evolved over the years. Older generations of process control systems were typically implemented using dedicated, centralized hardware. However, modern process control systems are typically implemented using a highly distributed network of workstations, intelligent controllers, smart field devices, and the like, some or all of which may perform a portion of the overall process control scheme. In particular, most modern process control systems include smart field devices and other process control components that are communicatively coupled to each other and/or to one or more controllers via one or more digital data busses. Of course, other non-smart field devices may also be directly coupled to controllers. In any event, field devices include, for example, input devices (e.g., devices such as sensors that provide status signals that are indicative of temperature, pressure, flow rate, etc.), as well as control operators or actuators that perform actions in response to commands received from controllers and/or other field devices. For example, a controller may send signals to a valve to increase pressure or flow, to a heater or chiller to change a temperature, to a mixer to agitate ingredients in a process control system, etc.

Smart field devices, whether they be input field devices or control devices, typically include a unique identifier programmed therein. A controller uses the unique identifier to address the field device (i.e., to communicate with the field device) and to determine the capabilities, status or condition, and role of the field device within the overall process control system.

When a field device (e.g., a valve, a temperature sensor, etc.) fails or is failing in the field, maintenance personnel typically replace the field device. However, before such a replacement may be made, a replacement device must be programmed, which includes storing the unique identifier used by the failed field device in the replacement field device. This programming is not typically performed in the field, but is usually carried out by maintenance personnel at a central station. Subsequent to programming at the central station, the replacement device is taken into the field and installed. In situations where multiple field devices are distributed across a wide geographical area, programming replacement components at a central station is time consuming because multiple trips from the field to the central station may be required, depending upon when maintenance personnel become aware of a need to replace the field devices.

In addition to unique identifiers, smart field devices also typically store other data and/or routines. Accordingly, in addition to programming replacement devices with the appropriate unique identifier, replacement devices must also be programmed with the latest versions of processes or routines stored in the failed devices at the time of their removal.

As will be readily appreciated from the foregoing, programming replacement field devices with unique identifiers, processes, routines and/or other process control data can be very cumbersome, especially in situations in which the field devices are distributed across wide geographical areas. Additionally, while the foregoing has described problems associated with replacing field device components, those having ordinary skill in the art will readily recognize that components other than field devices within a process control system are also cumbersome to replace. For example, the replacement of controllers, input/output (I/O) devices (wireless or wired), communications hubs, etc. also requires significant reprogramming effort. Accordingly, the replacement of any process control component or device and the reprogramming associated therewith can prove very time consuming and expensive.

### SUMMARY

Disclosed herein are methods, apparatus and articles of manufacture that provide modular monitoring, control and device management in a process control system. As disclosed herein, process control components include a removable memory device in which identifiers, device parameters, data, routines and/or processes may be stored. When a process control component having such a configuration is to be replaced, the removable memory device is extracted from a failed component and is installed in a replacement component. Because information desirable for the operation of the failed component is stored in the removable memory device, the replacement component having the removable memory device from the failed component installed therein may quickly and seamlessly replace the failed component (i.e., without adversely affecting other process control components and/or the performance of one or more process control routines being executed by those components).

According to a first example, a method of replacing a first field device of a process control system with a second field device, wherein the first field device includes a removable data storage device is disclosed. The method includes extracting the removable data storage device from the first field device and removing the first field device from the process control system. The method further includes installing the second field device into the process control system and installing the removable data storage device into the second field device.

According to a second example a method of configuring a field device includes installing a programmed removable data storage device into the field device, wherein the programmed removable data storage device includes information related to the field device and accessing the information related to the field device.

An example process control device may include a device processor, a memory coupled to the device processor and storing instructions to be executed by the device processor, wherein the memory further stores process control information related to the process control device and a removable storage device coupled to the device processor, wherein the removable storage device stores process control information provided by the device processor, and wherein the removable storage device is slideably engaged with the device processor.

An example removable storage device to be used with a field device may include an interface through which process control data related to the field device may pass and a security control coupled to the interface, wherein the security control limits access to information stored in the removable storage device. The removable storage device may further include a processor coupled to the security control and configured to receive process control data from the security control and a memory coupled to the processor and storing process control data.

### BRIEF DESCRIPTION OF THE DRAWINGS

FIG. 1 is a block diagram of an example of a process control system.

FIG. 2 is a block diagram of an example of the remote monitoring and control system of FIG. 1.

FIG. 3 is a block diagram of an example of a process control component.

FIG. 4 is a block diagram of an example of the removable storage device of FIG. 3.

FIG. 5 is a flow diagram of an example of a component processor reset process that may be carried out by the component processor of FIG. 3.

FIG. 6 is a flow diagram of an example of a report process that may be carried out by the component processor of FIG. 3.

FIG. 7 is a flow diagram of an example of a storage device reset process that may be carried out by the storage device processor of FIG. 4.

FIG. 8 is a flow diagram of an example of a callback process that may be carried out by the storage device processor of FIG. 4.

FIG. 9 is a flow diagram of an example of an alert process that may be carried out by the processors of FIGS. 3 and/or 4.

FIG. 10 is a flow diagram of an example of a new setting process that may be carried out by the processors of FIGS. 3 and/or 4.

### DETAILED DESCRIPTION

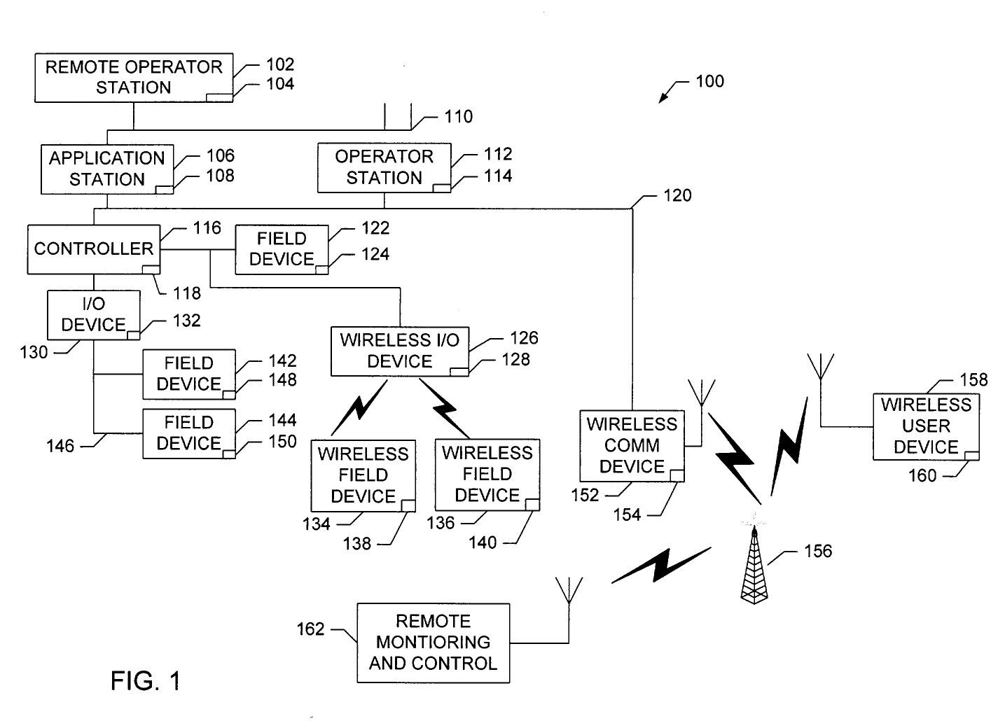

As shown in FIG. 1, an example process control system 100 includes a remote operator station 102 (including a removable storage device 104) that is coupled to an application station 106 (including a removable storage device 108) via a bus 110. The process control system 100 also includes an operator station 112 (including a removable storage device 114) that is coupled to the application station 106 and a controller 116 (including a removable storage device 118) via a second bus 120.

The remote operator station 102, the application station 106 and the operator station 112 may each be implemented using a personal computer (PC) executing instructions stored thereon. Alternatively, any or all of the remote operator station 102, the application station 106 and the operator station 112 may be implemented using workstations. Any or all of the remote operator station 102, the application station 106 and the operator station 112 may perform configuration tasks, enterprise optimization and/or management tasks, campaign management tasks, system diagnostic tasks, communication tasks, etc. For example, the operator station 112 may include software or routines that, when executed, enable a system operator to query the status of one or more field devices, controllers, etc., to run a diagnostic routine to diagnose one or more problems associate with an alert or alarm, etc. The application station 106, on the other hand, may include software or routines that, when executed, orchestrate the overall operation of the system 100 to carry out a batch process or some other process control scheme, coordinate communications between the remote operator station 102 and the operator station 112 or some other entity within the system 100, etc.

As described in detail below, any or all of the removable storage devices (e.g., the removable storage devices 104, 108, 114 and any other removable storage devices described below) shown and described herein may be implemented using smart cards including memory, processing and information security capabilities. Smart cards (also referred to as subscriber information module (SIM) cards) are commercially available from, for example, Samsung. Alternatively, the removable storage devices could be memory devices that do not include processing or security functionality. For example, the removable storage devices may be implemented using random access memory (RAM), read only memory (ROM) or any suitable combination thereof. Furthermore, while numerous components and devices are shown herein as including removable storage devices, such illustrations are merely examples. Accordingly, subsets of the components and devices shown in the drawings may include removable storage devices and other subsets may not include removable storage devices.

The use of removable storage devices in components of a process control system enables field personnel to replace worn, broken and/or defective hardware without losing the programming stored in the hardware to be replaced. In general, and as described in greater detail below, the removable storage device is removed from the component being replaced and is inserted into the component being installed. Accordingly, any process control information, device configuration parameters, algorithms, network security keys, security keys allowing access to the removable storage device memory, network information, communication addresses, etc. stored in the removable storage device of the component being replaced can be quickly assimilated by the replacement component. In addition, the removal and installation of the removable storage device may be carried out quickly in the field and with little, if any, probability of providing incorrect information to the replacement device. As a result, field devices and other process control system components can be replaced with minimal, if any, disruption to the overall operation of the process control system 100.

As described herein, the removable storage devices may be implemented in a number of different devices (e.g., field devices, controllers, I/O devices, etc.) In such arrangements various types of information may be stored on the removable storage devices. For example, the removable storage devices may store static information such as device settings, addressing information, configuration information, serial numbers, algorithms (e.g., custom or standard algorithms), security or access keys for wireless and/or wired networks and/or for the removable storage device, communication addresses, etc. The storage of static information such as configuration information is advantageous when devices are repaired or replaced in the field because the settings of such devices are stored on a media that may be removed and ported to a new device so that the new device can be configured quickly.

In addition to static, configuration-type information, removable storage devices may store dynamic information such as process control information. Examples of process control information may include totalized flow through a device, the last temperature read by a device, the last process control command received by or sent from a device, the state of various inputs and outputs of a device, a communication log, etc. Because of the temporal nature of the process control information, the process control information may be time stamped when it is written to the removable storage device. The storage of dynamic information (e.g., process control information) is advantageous because replacement devices maintain process continuity when they are installed by virtue of the information provided thereto by the removable storage device. For example, if a particular flow meter totalizes flow over time but needs to be repaired or replaced, the removable storage device from the flow meter to be replaced, which includes totalized flow, may be installed into a replacement flow meter that obtains the prior totalized flow from the removable storage device and can continue tracking flow from where the prior flow meter left off.

The buses 10, 120 may be conventional wired buses, local area networks (LANs), a wide area networks (WANs), the public switched telephone network (PSTN), the Internet and/or any other suitable communication media. Additionally, the buses 110, 120 may include wireless media such as, for example, cellular radio communication networks, etc.

As depicted by way of example in FIG. 1, a controller 116 is interfaced to, for example, one or more field devices 122 (including a removable storage device 124), a wireless I/O device 126 (including a removable storage device 128) and an I/O device 130 (including a removable storage device 132). The wireless I/O device 126 is further coupled to wireless field devices 134, 136, which include removable storage devices 138, 140, respectively. The wireless I/O device 126 is communicatively coupled to field devices 142, 144 via the controller 116 and a bus 146. The field devices 142, 144 include removable storage devices 148 and 150, respectively.

The controller 116 may be implemented using any desirable controller such as, for example, a DeltaV controller, which is commercially available from Fisher Rosemount Systems, Inc. In any case, such controllers are well known and, thus, are not described in greater detail herein. However, a commercially available controller would be modified to include a removable storage device and would be further modified to write information to the removable storage device.

The field device 122 can be any conventional (i.e., non-smart) field device. For example, the field device 122 could include a Hart 4-20 milliampere (mA) device that outputs a current proportional to parameters measured by the field device 122. In such an example, the field device 122 operates over dedicated wire lines that are not multiplexed between field devices. For example, if the field device 122 were a temperature sensor adapted to read temperatures between 0° centigrade (C.) and 100° C., the field device 122 outputs 4 mA when a temperature at or below 0° C. is sensed by the field device 122 and outputs 20 mA when a temperatures at or above 100° C. is sensed. Between the temperature extremes, the field device 122 outputs currents between 4 mA and 20 mA in proportion to the sensed temperature. The current that is output from the field device 122 is converted into a voltage representing the sensed temperature.

The wireless I/O device 126 of the example of FIG. 1 acts as an interface between the controller 116 and the wireless field devices 134, 136. The wireless signals exchanged by the wireless I/O device 126 and the wireless field devices 134, 136 may be analog or digital radio signals containing process control information. In addition to process control information, the wireless signals may include any other information for carrying out communications (e.g., protocol information, version information, timestamps, coding information, parity information, addressing information, etc.) The wireless signals may be exchanged via radio communications over of number of different frequency bands using any suitable modulation and/or coding schemes. In one example the wireless signals transmitted by and received at the wireless I/O device 126 may be Bluetooth-type signals and/or signals complying or not complying with any institute of electrical and electronic engineers (IEEE) protocol, such as any of the 802.11 protocols.

Radio communications may be used to connect one or more field devices 134, 136 to the wireless I/O device 126. The wireless I/O device 126 may be implemented using, for example, EmberNet from Ember Corporation, Axxon LLC Wireless technology from Axxon Corp or using spread spectrum radio communications over radio frequencies of 900 megahertz (MHz) and/or 2.4 gigahertz (GHz) using products such as those offered by AEROCOM, except that such commercially available devices do not include the removable storage device 128. Accordingly, such commercially available devices would need to be modified if they were to include a removable storage device and were to store information to the removable storable device. The radio communications may also make use of a standard, such as the IEEE 1451 wireless standard for wireless sensing.

The wireless field devices 134, 136 are configured to exchange information with the wireless I/O device 126. Accordingly, the wireless field devices 134, 136 are configured to operate using a communication scheme compatible with the wireless I/O device 126. For example, the wireless field devices 134, 136 may be configured to transmit and receive information in an analog or digital format at any desirable communication frequency using any desired modulation and/or communication protocol. The functionality of the wireless field devices 134, 136 may be implemented using devices available from EmberNet from Ember Corporation, Axxon LLC Wireless technology from Axxon Corp or using spread spectrum communications over radio frequencies of 900 MHz and/or 2.4 GHz using products such as those offered by AEROCOM. Examples of such devices using spread spectrum communications are the RF MicroAnalyzer System from Computational System, Inc. (CSI). Another example of a wireless device is the EchoNet wireless ultrasonic level transmitter from Flowline, which uses a cellular network to create network connections. The communications may also make use of a standard such as the IEEE 1451 wireless standard for wireless sensing. However, such commercially available devices do not currently include the removable storage devices 138, 140, which are described in further detail below.

The I/O device 130 interfaces the field devices 142, 144 to the controller 114 via the bus 146. The I/O device 130 may be hardwired to the field devices 142, 144 and may include addressed communication cards configured to exchange information with the field devices 142, 144. For example, the I/O device 130 may communicate with the field devices 142, 144 using the well-known Profibus protocol, HART protocol, the Foundation® Fieldbus, protocol, or any other suitable communication protocol. In operation, the I/O device 130 exchanges information with the field devices 142, 144. For example, the I/O device 130 may receive information from each of the field devices 142, 144 and may format the received information into a datastream or data packets that are passed to the controller 116. Likewise, the controller 116 may send messages or communication packages to the I/O device 130. Upon receiving the messages or communication packages from the controller 116, the I/O device 130 processes the information and sends relevant information to each field device 142, 144. For example, the communication package may include information to be distributed to the field device 142 and not to be distributed to the field device 144. In such an instance, the I/O device 130 would distribute the relevant information to the field device 142 and would not send such information to the field device 144. Although the example I/O device 130 includes enhanced functionality described below, the base functionality of the I/O device 130 may, for example, be implemented using hardware and/or software commercially available from Fisher Rosemount Systems, Inc.

As noted earlier, the I/O device 130 and the field devices 142, 144 may exchange information using any desired communication protocol (e.g., HART, Profibus, Fieldbus, etc.) Accordingly, the field devices 142, 144, which may be input devices (e.g., flow meters, temperature indicators, etc.) and/or output devices (e.g., valves, motors, etc.) are configured to exchange information with the I/O device 130 using like protocols.

The process control system 100, as shown in the example of FIG. 1, further includes a wireless communication device 152 coupled the controller 116 via the bus 120. In the example of FIG. 1, the wireless communication device 152 includes a removable storage device 154. The wireless communication device 152 is configured to carry out wireless communications over, for example, a broad geographical area. The wireless communication device 152 may be implemented using a network card and associated radio frequency (RF) hardware using a frequency and a protocol recognized by a wireless network 156.

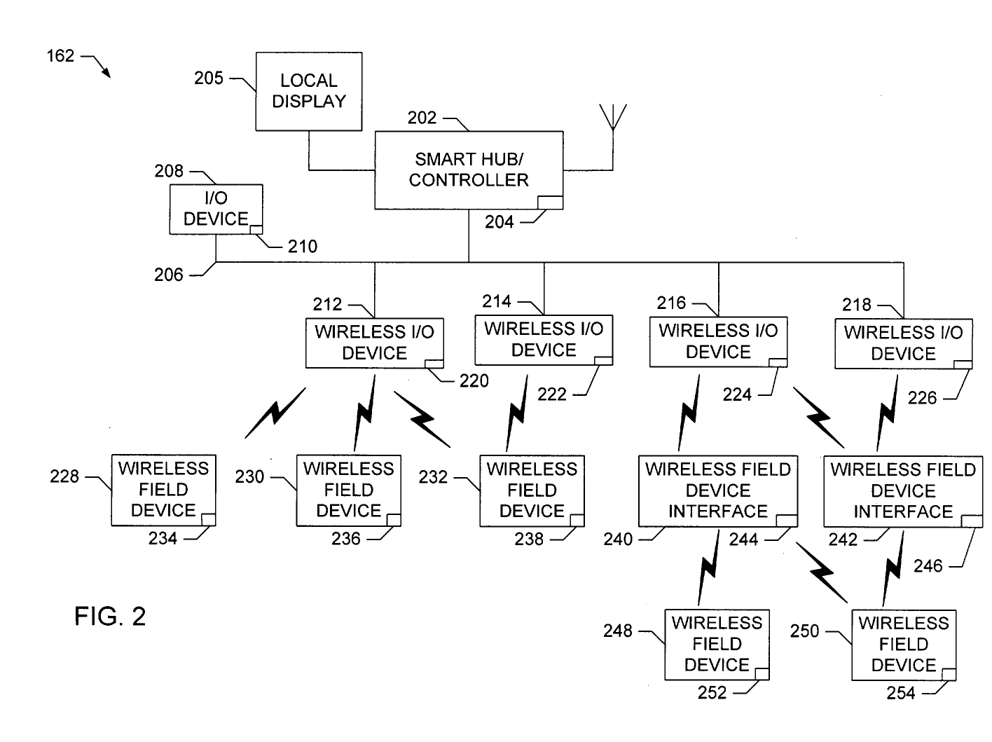

As will be readily recognized by those having ordinary skill in the communications art, the wireless communication device 152 transmits information in analog or digital format at suitable RF frequencies. The wireless communication device 152 provides communications connectivity for some or all of the application station 106, the operator station 112 and/or the controller 116. For example, the wireless communication device 152 may be in communication with a wireless network 156 that is further in communication with a wireless user device 158, which includes a removable storage device 160, and is further in communication with a remote monitoring and control system 162, further details of which are provided below in conjunction with FIG. 2.

The wireless communication device 152 may be any device configured or adapted to provide a network connection for the passage of data to and from a network. For example, the wireless communication device 152 may be a network card and associated RF hardware that connects to the wireless network 156 via a wired connection or a wireless radio communications connection. The wireless communication device 152 may be a wired or wireless modem, such as, for example, a cable modem, a digital subscriber line (DSL) modem or the like.

The wireless network 156 may include cellular or personal communication service (PCS) infrastructure. In such instances, the wireless communication device 152 may transmit and receive information in a format dictated by the wireless network 156. For example, if the wireless network 156 is an analog communication network, the wireless communication device 152 may transmit and receive information in analog format. Alternatively, if the wireless network 156 is digital infrastructure, the wireless communication device 152 may send and receive information in digital formats (e.g., time-division multiple access (TDMA), code-division multiple access (CDMA), etc.) Accordingly the wireless communication device 152 may be a tri-mode device that is adapted to send and receive communications in any and all of analog, TDMA or CDMA formats.

The wireless user device 158 may be implemented by, for example, a cellular telephone, a pager, a wireless-enabled personal digital assistant (PDA), etc. The wireless user device 158 is configured to receive, among other information, process control information from the wireless network 156. For example, the wireless communication device 152 may provide alerts, status indicators, etc. to the wireless user device 158 via the wireless network 156. Additionally or alternatively, a user may transfer data, settings, etc. to, for example, the controller 116, via the wireless network 156 and the wireless communication device 152.

The removable storage device 160 of the wireless user device 158 may store information pertinent to the operation of the wireless user device 158 and may also store information pertinent to the operation of one or more components of the system 100. For example, the removable storage device 160 may store names and telephone numbers pertinent to the operation of the wireless user device 158. Additionally or alternatively, the removable storage device 160 may store process or control information, such as settings, routines, parameters, etc. that are transferred to the controller 116 via the wireless network 156 and the wireless communication device 152.

As shown in the example of FIG. 2, the remote monitoring and control system 162 includes a smart hub/controller 202 having a removable storage device 204 and an associated local display 205. The smart hub/controller 202 is coupled by a bus 206 to an I/O device 208, which includes a removable storage device 210, and is further coupled to a number of wireless I/O devices 212-218, each of which includes a removable storage device 220-226, respectively. A number of field devices (not shown) may be coupled to the I/O device 208.

A number of wireless field devices may be interfaced to one or more of the wireless I/O devices 212-218. For example, as shown in FIG. 2, the wireless field devices 228-232 are interfaced to the wireless I/O device 212. Each of the wireless field devices 228-232 includes a removable storage device 234-238, respectively. The wireless field devices 228-233 are not, however, precluded from communicating with more than one wireless I/O device 212. For example, as shown in FIG. 2, the wireless field device 232 communicates not only with the wireless I/O device 212, but also communicates with the wireless I/O device 214.

Some of the wireless I/O devices (e.g., the wireless I/O devices 216 and 218) are coupled to wireless field device interfaces 240 and 242, which include removable storage devices 244 and 246, respectively. The wireless field device interfaces 240, 242 may be wireless communication hubs that transfer communications between wireless I/O devices 216, 218 and wireless field devices 248, 250 that include removable storage devices 252, 254, respectively. For example, wireless field device interfaces (e.g., 240 and 242) may be used to gather wireless signals from wireless field devices (e.g., 248 and 250) that are spread across a broad geographical area, such as, for example, wireless field devices spread throughout various areas of a manufacturing plant, and to communicate such signals to one or more wireless I/O devices (e.g., 216 and 218). Additionally, the wireless field device interfaces (e.g., 240 and 242) may distribute signals from the wireless I/O devices (e.g., 216 and 218) to wireless field devices 248, 250.

The smart hub/controller 202 may be implemented using hardware and/or software that provides connectivity to the wireless network 156 of FIG. 1 so that information may be exchanged between the smart hub/controller 202 and the controller 116 or any other suitable component shown in FIG. 1. In one example, the smart hub/controller 202 may be implemented using a commercially available system such as DeltaV with a specially engineered wireless I/O card. In one example, the wireless I/O card would be implemented using EmberNet from Ember Corporation, Axxon LLC Wireless technology from Axxon Corp or using spread spectrum radio communications over radio frequencies of 900 MHz and 2.4 GHz using products such as those offered by AEROCOM.

The I/O device 208, the wireless I/O devices 212-218, the wireless field devices 228-232 and 248-250 may be implemented as described in conjunction with like devices shown in FIG. 1.

The wireless field device interfaces 240, 242 serve as communication hubs between some of the wireless field devices 248, 250 and some of the wireless I/O devices 216, 218. The wireless field device interfaces 240, 242 may be implemented using EmberNet from Ember Corporation, Axxon LLC Wireless technology from Axxon Corp, using spread spectrum communications over radio frequencies of 900 MHz and/or 2.4 GHz using products such as those offered by AEROCOM, a cellular network to connect its transmitter, Bluetooth or other wireless communication standards. The protocols may include proprietary Modbus or a standard such as the IEEE 1451 wireless standard for wireless sensing.

The devices shown in FIGS. 1 and 2 as including removable storage devices typically include a device portion (e.g., a sensor, an actuator, etc.) that exchanges information with a processing portion. For example, a temperature measurement field device may include a temperature sensor (a device portion) that generates signals representative of temperature and passes the temperature-indicative signals to a processing portion including a device or component processor. Within the processing portion, the temperature signals may be compared to threshold temperature signals used to indicate if the temperature observed by the field device is too high or too low. As an additional example, if the device portion is that of a valve, a valve control signal would be generated by a processing portion and passed to an actuator that can change the position of the valve being controlled.

Even if the device is not a field device and is, for example, an I/O device or a wireless I/O device, such devices include a device portion configured to, for example, receive input signals from multiple field devices. For example, a controller may include a processing portion including hardware and/or software typically associated with a controller. In such an arrangement, the processing portion would handle any processing of the received signals, as well as handling the routing and distribution of the received signals to one or more controllers.

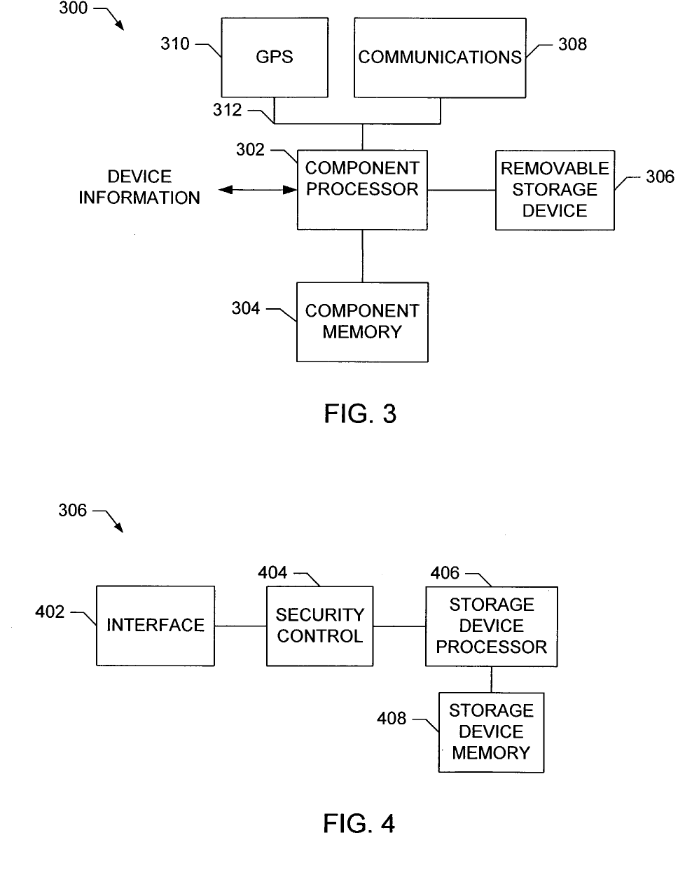

Turning to FIG. 3, a processing portion 300, which could be implemented as part of any one of the components of FIGS. 1 and 2, includes a component processor 302 having an associated component memory 304. The processing portion 300 further includes a removable storage device 306, a communications block 308 and, in the illustrated example, a global positioning system receiver 310. The communications block 308 and the global positioning system 310 are coupled to the component processor 302 via a bus 312.

The component processor 302 may be any microprocessor and/or microcontroller that may include on-board memory. Alternatively, the component processor 302 may be a digital signal processor (DSP), an application-specific integrated circuit (ASIC), a programmable logic controller, etc.

The component memory 304 may be a ROM device, such as a non-volatile ROM (NVROM), of which flash memory is one type. The memory 204 could also be a RAM device. Additionally, the component memory 304 may be any combination of ROM or RAM integrated together or implemented using separate devices. As a further alternative, the component memory 304 could any other type of optical and/or magnetic media, such as a hard disk, a compact disk (CD), a digital versatile disk (DVD), etc. As described below with respect to the included flow diagrams, the component memory 304 may store instructions to be executed by the component processor 302.

The component processor 302 and component memory 304 could also be combined and implemented using a SIM. In such cases the SIM would have a relatively small processor (currently ¼-½ million instructions per second (MIP)) and a relatively small amount of memory (currently 32 kilobytes). The SIM's could also be programmed to implement a standard such as one of the cellular standards (e.g. GSM 11.11).

As described below in conjunction with FIG. 4, the removable storage device 306 may be implemented using, for example, a smart card microcontroller having on-board memory that is commercially available from a number of different manufacturers. In such an arrangement, the removable storage device 306 may be slideably engaged with a connector (not shown) that is connected to the component processor 302. In the alternative, the removable storage device 306 could be implemented using a CD, a 3.5 inch disk, a removable flash-based device, such as a jump drive or the like, RAM, ROM or any suitable combination of the foregoing. The removable storage device 306 may include on-board security enabling protection of the information stored thereon. In the alternative, on-board security may not be included in the removable storage device 306.

The communications block 308 provides connectivity between the processing portion 300 and any other networks or devices with which communication is desired. For example, the communications block 308 may be implemented by wireless communications hardware and software, such as may be found in cellular telephones, PDAs and/or any other wireless communication device. Alternatively, the communications block 308 could be implemented for wired communication, in which case the wireless communications block 308 may be implemented using a network card, such as an Ethernet E-card. Additionally, if wired communication is desired, the communications block 308 could be implemented using a conventional modem that is configured to exchange information with other modems over the PSTN.

The GPS receiver 310 may be implemented in dedicated hardware that is commercially available from, for example, SiRF's SiRFstarII GPS baseband core or more proprietary hardware built using chipsets from Fuji or Motorola. As will be readily appreciated by those having ordinary skill in the art, the GPS receiver 310 receives wireless signals from a number of signal sources (e.g., satellites or ground-based installations) and calculates the location of the processing portion 300 based thereon. In operation, the GPS receiver 310 determines the geographic position of the processing portion 300 and passes the location information to the component processor 302 via the bus 312.

In some arrangements, the GPS receiver 310 may be used to thwart device theft by providing the geographic location of the device that someone is attempting to steal. For example, a device may include a tamper switch (not shown) that indicates when an attempt to steal the device is being made. Upon such an indication, information from the GPS receiver 310 may be reported to the processing portion 300, which may route such information back to, for example, a service center. In the alternative, without the need for a tamper switch, unexpected position changes may be reported and used to detect potential or actual theft. Upon the detection of a suspected theft, one or more reporting and/or callback routines (as described below) may be initiated to report the unexpected geographical change of the device.

As shown in the example of FIG. 4, one example of the removable storage device 306 includes an interface 402 that is coupled to a security control 404, which, in turn, is coupled to a storage device processor 406. The removable storage device 306 further includes a storage device memory 408 communicatively coupled to the storage device processor 406. As will be readily appreciated by those having ordinary skill in the art, the removable storage device 306, as shown in the example of FIG. 4, may be implemented using commercially available smart card microcontroller technology. For example, the removable storage device 306 may be implemented using a device that is commercially available from Samsung Electronics.

In an example implementation, the storage device memory 408 may store configuration information, custom or standard algorithms, security and/or network access keys, network addresses, process control parameters and the like. As described in detail below, some or all of the information held in the storage device memory 408 may be transferred to the component processor 302. Additionally, some or all of the information received by the component processor 302 may be stored in the storage device memory 408 for later retrieval or use.

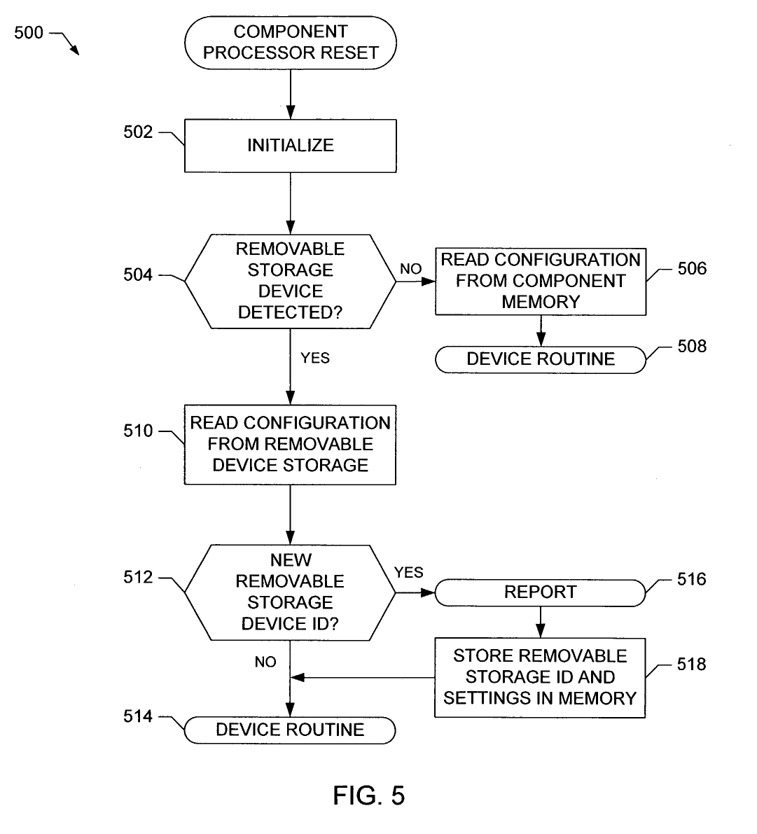

The detailed operational aspects pertinent to the interaction of the component processor 302 and the removable storage device 306 are provided in detail with respect to FIGS. 5-10, below. However, in general, the removable storage device 306 is programmed with information pertinent to the component (e.g., any of the components shown in FIGS. 1 and 2). Because the information pertinent to the component is stored in the removable storage device 306, the removable storage device 306 may be separated from the processing portion 300 and installed into another processing portion. Accordingly, in the field, devices and processing portions may be replaced without the need to reprogram such devices by removing the removable storage device 306 from a prior used processing portion 300 and installing the removable storage device 306 into the new processing portion. Such an arrangement eliminates the necessity of reprogramming the processing portion 300 when hardware is exchanged in the field.

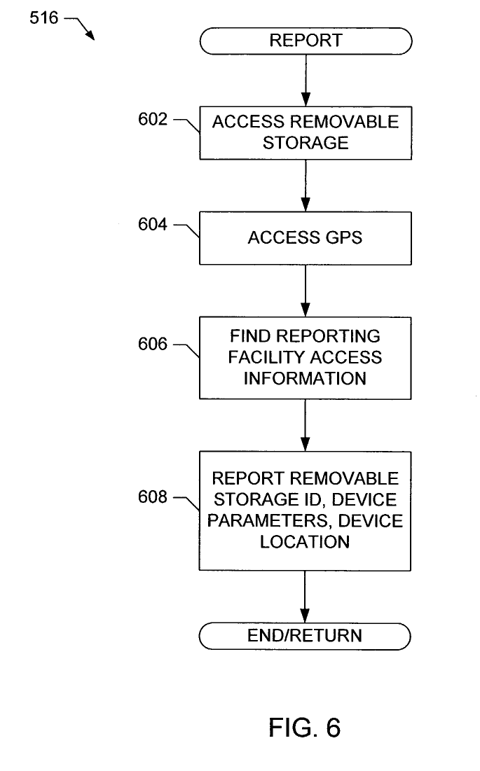

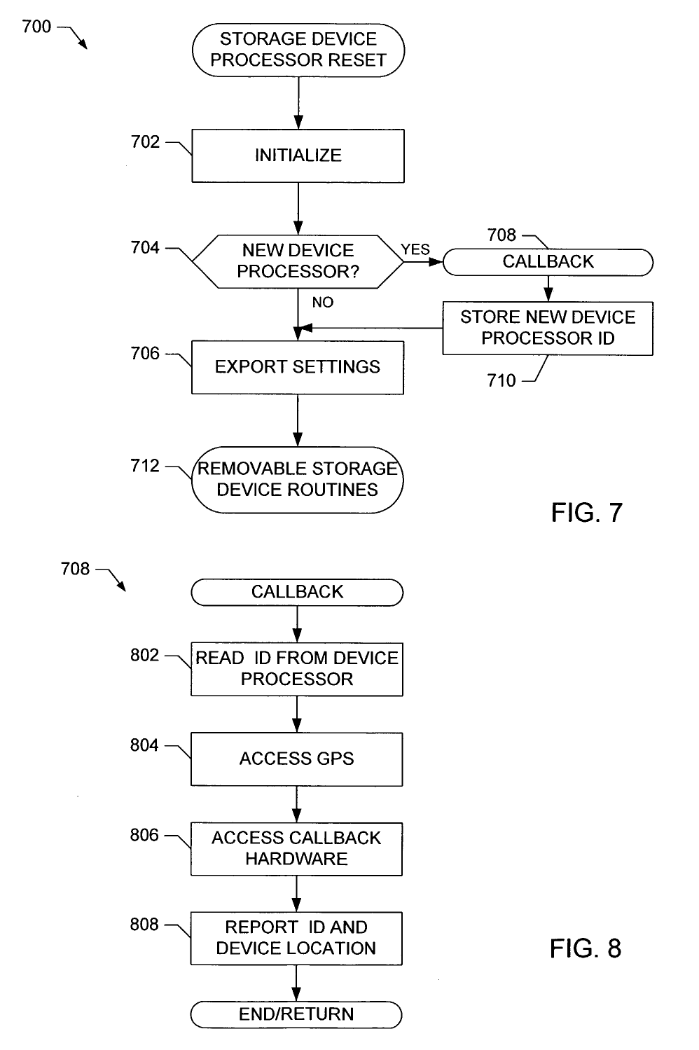

The interaction of the component processor 302 of the processing portion 300 and the removable storage device 306, as described in conjunction with FIG. 4, will now be described with reference to FIGS. 5-10. In particular, FIGS. 5 and 6 describe operation of the component processor 302 and FIGS. 7-10 describe the operation of the removable storage device 306.

As shown in FIG. 5, a component processor reset process 500 commences when the component processor 302 receives a reset signal on a reset pin of the component processor. The reset signal may be due to the status of a reset line of the processor and/or may be due to the processor having been just powered up. The process 500 commences by initializing the component processor 302 (block 502). Initialization may include clearing component processor memory, setting processor output ports to various predefined states, zeroing counters, clearing buffers, etc.

After initialization (block 502) it is determined if a removable storage device is detected (block 504). Detection may be carried out by the component processor 302 polling lines connecting the component processor 302 and the removable storage device 306 to determine if a removable storage device 306 is present. Alternatively, the component processor 302 may initiate a handshake that would communicate with a removable storage device 306. As part of the handshake, the component processor 302 waits to receive communication from a removable storage device 306. If the component processor 302 does not receive communication from a removable storage device, the component processor 302 determines that no removable storage device is present (block 504).

If no removable storage device is detected (block 504), configuration information for the component with which the processing portion 300 operates is read from the component memory 304 (block 506). The configuration information is used to setup and configure the component processor 302 so that the component processor 302 is ready to operate with its associated component.

After the configuration information is read from component memory (block 506), a device routine is carried out (block 508). The device routine or routines include instructions carried out by the component processor 302 that give the component processor 302 functionality needed for the component processor 302 to interact with the device information required by or provided by the device in which the processing portion 300 is installed. Alternatively, if a removable storage device is detected (block 504) the component processor 302 reads configuration information from the detected removable storage device 306 (block 510).

After the configuration information is read from the removable storage device 306 (block 510), it is determined if a new removable storage device identifier (ID) is detected (block 512). If a new removable storage device ID is not detected (block 512), the device routine is carried out (block 514). In the alternative, if a new removable storage ID is detected (block 512) a report routine, as described in conjunction with FIG. 6 below, is carried out (block 516) and the removable storage device ID and settings stored in the removable storage device 306 are read (block 518), after which the device routine is carried out (block 514).

As shown in FIG. 6, the report routine 516, which may be carried out by the component processor 302, begins by accessing the removable storage device 306 (block 602) and accessing the GPS receiver 310 (block 604). Access information for a reporting facility is then determined (block 606). Access information may be stored in look up table format within the removable storage device 306 and may include an Internet protocol (IP) address, a telephone number, or any other suitable access information, such as, for example, an e-mail address or a web page address.

After the removable storage device 306 and the GPS receiver 310 have been accessed and access information is found for reporting facility (blocks 602-606), the removable storage ID, device parameters, device location and any other suitable information is reported (uploaded) from the processing portion 300 to the reporting facility or service center (block 608). The reporting activity may require one ore more network access keys stored in the removable storage device 306. The reporting facility or service center may be operated by, for example, a supplier of the component, a maintenance service for the component and/or any other entity that it is desirable to keep abreast of changes between the component processor 302 and the removable storage device 306. Additionally, as part of the reporting activity the service center may provide downloads of programming information such as settings and firmware and/or software upgrades to the processing portion from the service center.

While FIGS. 5 and 6 pertain to operations that take place when the component processor 302 receives a reset signal, FIG. 7 illustrates an example storage device processor reset process 700 that may be carried out when the storage device processor 406 of the removable storage device 306 receives a reset signal. As described in conjunction with the component processor 302, the storage device processor 406 may receive a reset when to a reset line on the storage device processor 406 held in a particular state or during the power up of the storage device processor 406. Upon reset, the storage device processor 406 initializes (block 702) by resetting memory locations, buffer contents, output ports, etc.

After initialization is complete (block 702), it is determined if the removable storage device 306 is interfaced to a new component processor (e.g., the component processor 302) (block 704). To determine if the removable storage device 306 is interfaced to a new component processor, the removable storage device 306 may read an identifier (ID) from a particular memory location within the component processor. If the ID read from the component processor is different than an ID stored in the removable storage device 306, the component processor is characterized as new (e.g., not the last component processor to which the removable storage device 306 was coupled).

If it is determined that the component processor is not new (block 704), the removable storage device 306 exports its settings to the device processor 302 (block 706). Alternatively, if it is determined that the device processor to which the removable storage device 306 is connected is new (block 704), a callback process (block 708), as described in detail in conjunction with FIG. 8, is carried out to report back information to, for example, a reporting facility or service center. Additionally, as noted below, various settings or algorithms may be transferred (downloaded) to the removable storage device 306 during the callback process. Accordingly, the callback process may facilitate a two-way exchange of information. After the callback is complete (block 708), the new component processor ID is stored (block 710). The settings from the removable storage device 306 are then exported to the component processor 302 (block 706).

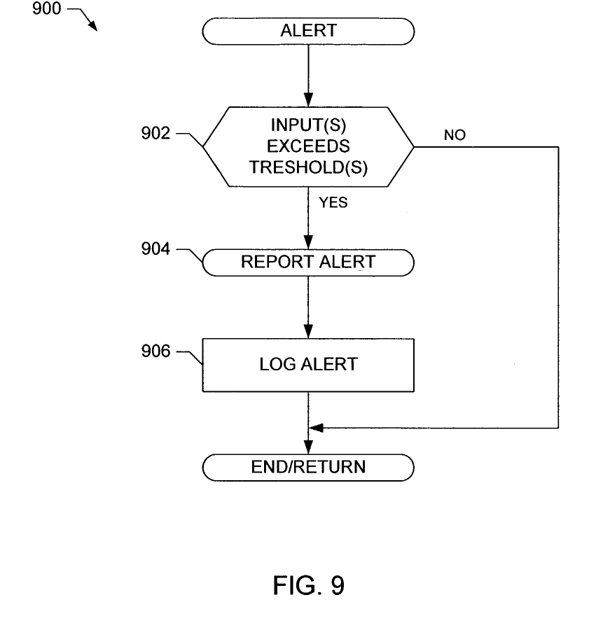

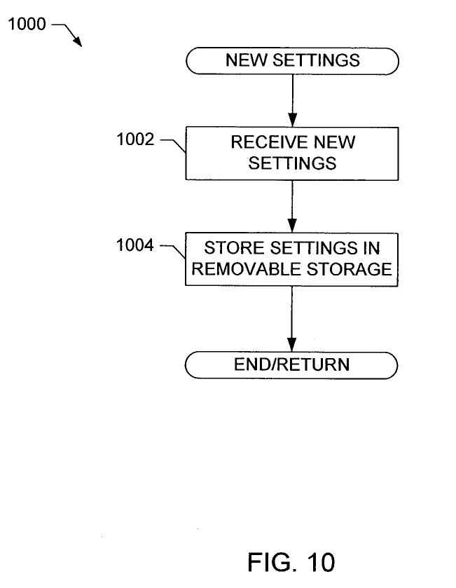

After the settings have been exported (block 706), removable device storage routines are executed (block 712). The removable storage device routines include various instructions, processes or sub-processes that are executed by the storage device processor 406 of the removable storage device 306 (e.g., the removable storage device routines may include an alert routine (FIG. 9), a new settings routine (FIG. 10), or any other suitable routines that are advantageous to the operation of the removable storage device 306 in conjunction with the component processor 302).

As shown in FIG. 8, the callback process 708, which may be executed as part of the storage processor reset process 700, begins by reading the ID from the device processor (block 802). After the ID is read from the device processor (block 802), the GPS receiver is accessed (block 804) and the location of the processing portion 300 is determined therefrom.

After the geographical location of the processing portion 300 is determined, the callback hardware is then accessed to enable reporting from the removable storage device 306 to a central station or service center (block 806). The callback hardware may be accessed through the component processor 302 to give the removable storage device 306 access to the communications block 308. The address of the entity to which the callback is placed may be determined in part by the physical location of the processing portion 300 as determined by the GPS receiver 310 (block 804). For example, the processing portion 300 may include a look up table listing various geographical locations and the callback information corresponding thereto. Alternatively or additionally, the look up table may be stored in the removable storage device 306. In such an arrangement, the callback could be placed to the geographical location nearest the processing portion 300.

As will be readily appreciated by those having ordinary skill in the art, the callback could be made via modem and PSTN lines, via a modem and the Internet or via any other suitable communication path that is facilitated by the communication block 308. Additionally, the callback may require the use of one or more network access keys stored within the removable storage device 306. After the communication block 308 is controlled to initiate a callback, the ID and device location are reported back to the central station or service center (block 808). During the callback, some or all of the settings, parameters, algorithms, etc. may be uploaded to the service center for storage and/or processing.

The removable storage device 306 and/or the component processor 302 may also be programmed to include an alert process 900, as shown in FIG. 9. Through the execution of the alert process 900, the removable storage device 306 may receive relevant information from the component processor 302. The alert process 900 begins by determining if any inputs of device information exceed any thresholds set within the component processor 302 and/or the removable storage device 306 (block 902). If no inputs exceed any thresholds (block 902), the alert process 900 ends execution and returns control to its calling routine.

Alternatively, if any input(s) exceed any of the threshold(s) (block 902), a report alert process may be carried out (block 904), during which the removable storage device 306 may access the communications block 308 via the component process of 302 to report the fact that an alert has occurred. After the report alert process (block 904) completes execution, the alert is logged (block 906), thereby storing within the removable storage device 306 and/or the component memory 304 an indication that the alert occurred. After the alert has been logged, the alert process 900 terminates its execution.

A new settings process 1000 (as shown in FIG. 10) may be carried out by the removable storage device 306 and/or the component processor 302 to ensure that settings within the component processor 302 are accurately reflected in the removable storage device 306. The new settings process 1000 begins when new settings are received (block 1002). The new settings may be received via the communications block 308 and the component processor 302.

The newly received settings are stored in memory 408 within the removable storage device 306 (block 1004) and the process returns control to its calling routine. Subsequent instructions may load the new settings from the removable storage device 306 into the component processor 302 and/or the component memory 304.

Although certain apparatus constructed in accordance with the teachings of the invention have been described herein, the scope of coverage of this patent is not limited thereto. On the contrary, this patent covers all apparatuses, methods and articles of manufacture of the teachings of the invention fairly falling within the scope of the appended claims either literally or under the doctrine of equivalents.

What is claimed is:

1. A method of replacing a first field device of a process control system with a second field device, wherein the first field device includes a removable data storage device, the method comprising:
extracting the removable data storage device from the first field device;
removing the first field device from the process control system;
installing the second field device into the process control system; and
installing the removable data storage device into the second field device.

2. A method as defined by claim 1, wherein the removable data storage device comprises a smart card.

3. A method as defined by claim 2, wherein extracting the removable data storage device from the first field device comprises sliding the smart card from a connector in the first field device.

4. A method as defined by claim 2, wherein installing the removable storage device into the second field device comprises sliding the smart card into a connector in the second field device.

5. A method as defined by claim 2, further comprising transferring information in the first field device into the smart card before the smart card is extracted from the first field device.

6. A method as defined by claim 2, further comprising transferring information stored in the smart card into the second field device.

7. A method as defined by claim 6, wherein the information stored in the smart card comprises device configuration data.

8. A method as defined by claim 6, wherein the information stored in the smart card comprises field device configuration data.

9. A method as defined by claim 6, wherein the information stored in the smart card comprises process control system data.

10. A method as defined by claim 6, wherein the information stored in the smart card comprises instructions to be executed by the second field device.

11. A method as defined by claim 10, wherein the instructions comprise threshold comparison instructions.

12. A method as defined by claim 6, wherein the information stored in the smart card comprises process control variable thresholds.

13. A method as defined by claim 1, further comprising executing a reporting process to transfer information from the second field device to an alternate location.

14. A method as defined by claim 13, wherein transferring information from the second field device to an alternate location comprises transferring one or more of configuration information and programming information.

15. A method as defined by claim 13, wherein the reporting process comprises determining a geographical location of the second field device.

16. A method as defined by claim 13, wherein the reporting process comprises receiving information at the second field device from the alternate location.

17. A method as defined by claim 16, wherein transferring information from the second field device to an alternate location comprises transferring one or more of configuration information and programming information.

18. A method as defined by claim 17, wherein the alternate location comprises a service center.

19. A method of configuring a field device, the method comprising:
installing a programmed removable data storage device into the field device, wherein the programmed removable data storage device includes information related to the field device; and
accessing the information related to the field device.

20. A method as defined by claim 19, wherein the removable data storage device comprises a smart card.

21. A method as defined by claim 20, wherein installing the programmed removable data storage device into the field device comprises sliding the smart card into a connector in the field device.

22. A method as defined by claim 19, further comprising transferring the information related to the field device from the programmed removable data storage device into a memory of the field device.

23. A method as defined by claim 19, further comprising storing the information related to the field device into the removable data storage device.

24. A method as defined by claim 19, wherein the information related to the process control device comprises device configuration data.

25. A method as defined by claim 19, wherein the information related to the process control device comprises process control system data.

26. A method as defined by claim 19, wherein the information related to the process control device comprises instructions to be executed by the field device.

27. A method as defined by claim 26, wherein the instructions comprise threshold comparison instructions.

28. A method as defined by claim 19, wherein the information related to the field device comprises process control variable thresholds.

29. A method as defined by claim 19, further comprising transferring one or more of configuration information and programming information from an alternate location to the field device.

30. A method as defined by claim 29, wherein the alternate location comprises a service center.

31. A process control device comprising:
a device processor;
a memory coupled to the device processor and storing instructions to be executed by the device processor, wherein the memory further stores process control information related to the process control device; and
a removable storage device coupled to the device processor, wherein the removable storage device stores process control information provided by the device processor, and wherein the removable storage device is slideably engaged with the device processor.

32. A process control device as defined by claim 31, wherein the removable storage device comprises a smart card.

33. A process control device as defined by claim 31, wherein the process control information comprises process control data.

34. A process control device as defined by claim 31, wherein the process control information comprises instructions to be executed by the device processor.

35. A process control device as defined by claim 31, wherein the process control information comprises one or more access keys.

36. A process control device as defined by claim 35, wherein one or more of the access keys comprises a network key.

37. A process control device as defined by claim 35, wherein one or more of the access keys comprises an access key to provide access to the removable storage device.

38. A process control device as defined by claim 31, further comprising a position locating device.

39. A process control device as defined by claim 38, wherein the process control information comprises instructions to report a position of the process control device to an alternate location when the position of the process control device changes.

40. A process control device as defined by claim 39, wherein the alternate location comprises a service center.

41. A process control device as defined by claim 38, further comprising a theft detection device, wherein the process control information comprises instructions to report a position of the process control device to an alternate location in response to a signal from the theft detection device.

42. A process control device as defined by claim 41, wherein the theft detection device comprises a tamper switch.

43. A removable storage device to be used with a field device, the removable storage device comprising:
an interface through which process control data related to the field device may pass;
a security control coupled to the interface, wherein the security control limits access to information stored in the removable storage device;
a processor coupled to the security control and configured to receive process control data from the security control; and
a memory coupled to the processor and storing process control data.

44. A removable storage device as defined by claim 43, wherein the process control data comprises process control data.

45. A removable storage device as defined by claim 43, wherein the process control data comprises instructions to be executed.

46. A removable storage device as defined by claim 43, wherein the process control data comprises a key permitting access to a wireless network.
